(19) United States
(12) Patent Application Publication
(10) Pub. No.: US 2007/0253134 A1
(43) Pub. Date: Nov. 1, 2007

(54) Protection of EMC filter components due to failure of boost stage/circuit to prevent smoke, sound or fire in a boost stage under fault condition

(76) Inventors: Kevin R. Covi, Glenford, NY (US); Timothy C. Daun-Lindberg, Rochester, MN (US); Richard J. Fishbune, Rochester, MN (US); William Hemena, Sahuarita, AZ (US); Randhir S. Malik, Cary, NC (US)

Correspondence Address: DILLON & YUDELL LLP, 8911 N. CAPITAL OF TEXAS HWY.,, SUITE 2110, AUSTIN, TX, 78759, US

(21) Appl. No.: 11/411,663

(22) Filed: Apr. 26, 2006

(51) Int. Cl. H01H 73/00

(52) U.S. Cl. 361/115

(57) ABSTRACT

A circuit device and method for protecting EMC components from fault conditions that may negatively affect the components, such as high power dissipation in EMC components when/if the boost stage stops working or malfunctions and preventing smoke and fire in case the boost stage switching device fails, shorts, or is defective. The device is designed so that the chopper stage (following the boost stage) is latched off if/whenever the boost stage stops working. According to the methods of the invention, whenever such a fault occurs at the boost stage, the circuit immediately disables the stage that provides power to the output load (i.e., load-power-supply stage). This disabling of the load-power-supply stage then prevents very high currents from flowing through the EMC components and thus protects the EMC components from overheating and/or causing a fire or smoke.

### BACKGROUND OF THE INVENTION

1. Technical Field

The present invention relates generally to electronic circuits and specifically to electronic circuit devices utilized for power applications. Still more particularly, the present invention relates to an electronic circuit device and method for responding to fault conditions to protect EMC components.

2. Description of the Related Art

Conventional power circuits typically employ a boost stage to enable predictable power dissipation to the end circuit. The boost stages comprise electronic circuit components and are often susceptible to faults that may cause the boost stage to malfunction and/or stop working. When such malfunction of the boost stage occurs, it leads to high power dissipation in the EMC components, which is potentially fatal to the circuit. Additionally, when the boost stage switching device fails, shorts-out, or is defective, a build up of smoke and fire may occur within the boost stage switching device. Thus, for example, the boost stage may stop working either due to malfunction of the PWM or the antismoke fast blow fuse opens up due to failure of the boost MOSFET. At present there is no solution against this sort of problem.

During conventional operation, if the boost stage fails, whether due to a node remaining low or antismoke fuse opening up, the current through the components of the EMC filter will double. This will cause four times (4×) dissipation in the EMC filter components. There are several types of common fault conditions with conventional designs. The first condition occurs when the device temperature is higher than a predefined threshold causing the EMC devices to overheat and/or burn out. The second fault condition occurs when the MOSFET shorts, resulting in a large current flowing. The third condition occurs when the MOSFET shorts. Other fault conditions may often occur with conventional circuit designs.

### SUMMARY OF THE INVENTION

Disclosed is a circuit device and method for protecting EMC components from fault conditions that may negatively affect the components. In one implementation, a circuit device and method are provided to prevent high power dissipation in EMC components when/if the boost stage stops working or malfunctions. In another related implementation, an expanded circuit device and method prevents smoke and fire in case the boost stage switching device fails, shorts, or is defective.

The circuit device is designed so that the chopper stage (i.e., the stage that follows the boost stage) is latched off if/whenever the boost stage stops working. According to the methods of the invention, whenever such a fault occurs at the boost stage, the circuit immediately disables the stage that provides power to the output load (i.e., load-power-supply stage). This disabling of the load-power-supply stage then prevents very high currents from flowing through the EMC components and thus protects the EMC components from overheating and causing smoke and fire.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram representation of the circuit device with EMC components indicating the position of directed sensors and response components (A, B, C) that prevent exposure to overheating from fault conditions according to one embodiment of the invention;

FIG. 2 is a block diagram representation of an advanced design of the circuit device configured to shut-of the load-supply stage to protect boost stage components when under a fault condition according to one embodiment of the invention; and

FIG. 3 is a high level flow chart of the process of determining when to shut-of the load-supply stage according to one embodiment of the invention.

### DETAILED DESCRIPTION OF AN ILLUSTRATIVE EMBODIMENT

The present invention provides a circuit device and method for protecting electromagnetic compatibility (EMC) components from fault conditions that may negatively affect the components. In one implementation, a circuit device and method are provided to prevent high power dissipation in EMC components when/if the boost stage stops working or malfunctions. In another related implementation, an expanded circuit device and method prevents smoke and fire in case the boost stage switching device fails, shorts, or is defective.

The circuit device is designed so that the chopper stage (i.e., the stage that follows the boost stage) is latched off if/whenever the boost stage stops working. According to the methods of the invention, whenever such a fault occurs at the boost stage, the circuit immediately disables the stage that provides power to the output load (i.e., load-power-supply stage). This disabling of the load-power-supply stage then prevents very high currents from flowing through the EMC components and thus protects the EMC components from overheating and causing smoke and fire.

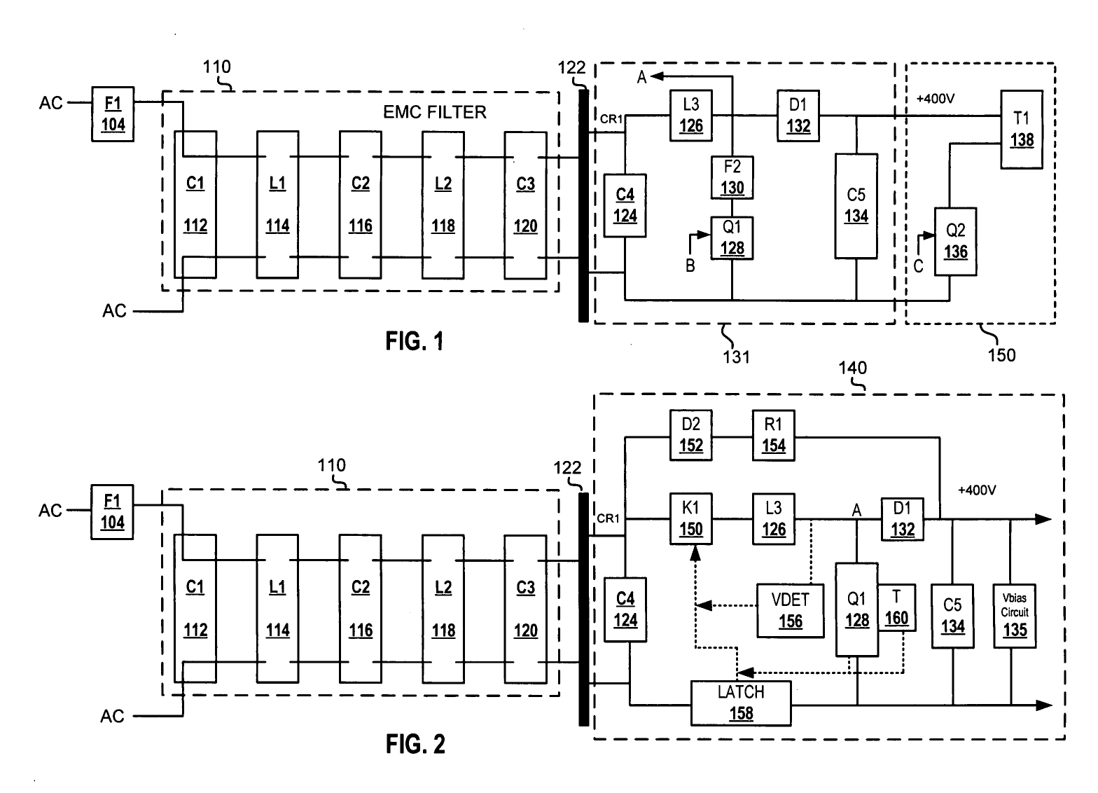

Referring now to the figures, and specifically FIG. 2, wherein is presented a configuration of circuit devices design according to one embodiment of the invention. The configuration provides three different mechanisms for detecting and responding to the occurrence of a fault condition within the device. Within the descriptions of FIG. 2, similar elements are provided similar names and reference numerals as those of the previous figure. Where a later figure utilizes the element in a different context or with different functionality, the element is provided a different leading numeral representative of the figure number (e.g, 1xx for FIGS. 1 and 2xx for FIG. 2). The specific numerals assigned to the elements are provided solely to aid in the description and not meant to imply any limitations (structural or functional) on the invention.

FIG. 1 illustrates components of the circuit design with EMC filter 110, coupled to the boost stage 131 and the chopper stage 150 indicating the position of directed sensors and response mechanisms at nodes (A, B, C) according to one embodiment of the invention. As shown, EMC filter 110 comprises alternating capacitors (C1 112, C2 116, C3 120) and inductors (L1 114, L2 118). EMC filter couples boost stage 131 via AC bridge CR1 122. Chopper stage 150 comprises transistor Q2 136 connected to input terminals of transformer T1 138.

Boost stage 131 comprises capacitor (C4) 124 coupled to inductor L3 126, fuse (F2) 130, transistor (Q1) 128, diode (D1) 132, and capacitor C5 134. Fuse f2 130 connects to the node between L3 126 and D1 132, which is labeled Node A in the figure. Node A is the high frequency (70-100 KHz), high voltage switching node. Node B is the gate voltage fed by a boost pulse width modulating signal. Node C is the gate of MOSFET Q2 driven by the CHOP pulse width modulated signal. In operation of the circuit design of FIG. 1, MOSFET Q2 136 is latched based on the status of the voltage across capacitor 134.

With specific reference now to FIG. 2, there is illustrated the complete circuit implementation of the features of the invention. Several of the components overlap with those of FIG. 1 and have been previously described. As with FIG. 1, the boost stage 130 of FIG. 2 comprises L3 126, Q1 128, D1 132 and C5 134.

As is further shown by FIG. 2, additional circuit components are provided within differently configured boost stage 140 to enable the fault tolerant features of the invention. Among these additional components are: semiconductor switch (or relay) K1 150 connected to inductor L3 126 and a branch comprising diode D2 152 and resistor R1 154 coupled parallel to boost stage components between CR1 122 and C5 134. Relay K1 150 opens (or shuts off) whenever a fault condition is reported within boost stage 140. D2 152 and R1 154 are utilized to pre-charge the boost capacitor (C5) 134 to provide energy for the bias circuitry and/or to provide power to the control circuit.

Other sensing (sensor) components are also added to boost stage 140, including voltage determination logic (or sensor) 156, current source latch 158, and temperature sensing logic (or thermometer) T 160. Each of these three components are utilized to monitor the specific operating parameter (voltage, current and temperature), respectively, and each provide feedback to the relay K1 150, which responds to an over-the-threshold reading from any one of these sensors 156, 158, or 160 by switching off the relay K1 150.

Referring to nodes A, B, and C of FIG. 1, during operation of the circuit (with re-configured boost stage 140), if the boost stage 140 fails, e.g., either due to node B remaining low or antismoke fuse F2 opening up, the current through the components of EMC filter 110 does not double and/or cause an increase of up to four times the dissipation in the filter components, as with conventional designs. Rather, whenever sensing node A does not switch at high frequency (approximately 70-100 kHz) for approximately 5 seconds, node C connected to the gate of Q2 136 is latched low. This latching of Q2 136 shuts down the chopper stage 150 and there will be no power delivered to the system load. Thus a fault condition that conventionally would have caused smoke and fire due to excessive power dissipation in the EMC filter components is prevented.

Once the bias circuit is in operation, relay K1 150 is closed and the boost stage 130 starts operating normally. Under a fault condition, including either a MOSFET being defective or the control circuit not operating properly, the invention provides the mechanisms by which the primary energy source is disconnected from the MOSFET switch Q1 128 as well as the EMC filter 110.

The disclosed method of the invention comprises monitoring one or more of three operating parameters of the MOSFET (Q1 128): (1) the current through the MOSFET Q1 128; (2) the voltage across the MOSFET Q1 128; and (3) the temperature across the MOSFET Q1 128.

The invention thus serves to correct or substantially eliminate the problems with each of three types of fault conditions: (1) The first condition occurs when the device temperature is higher than the predefined threshold temperature, as detected by the temperature thermometer (T). When this condition is observed/detected by the thermometer T, the relay K1 150 is turned off; (2) The second fault condition occurs when the MOSFET shorts, resulting in a large current beginning to flow through the current sensing circuitry (source latch) 158. This condition also turns of the relay K1 150; (3) The third condition that is monitored involves the MOSFET Q1 128 shorting and node A remaining low for more than 1 ms. Occurrence of this condition also triggers the relay K1 150 to turn off. Accordingly, for each condition, the relay turns off (opens) as the particular event/condition occurs, and no smoke or burn occurs even when the MOSFET Q1 128 fails.

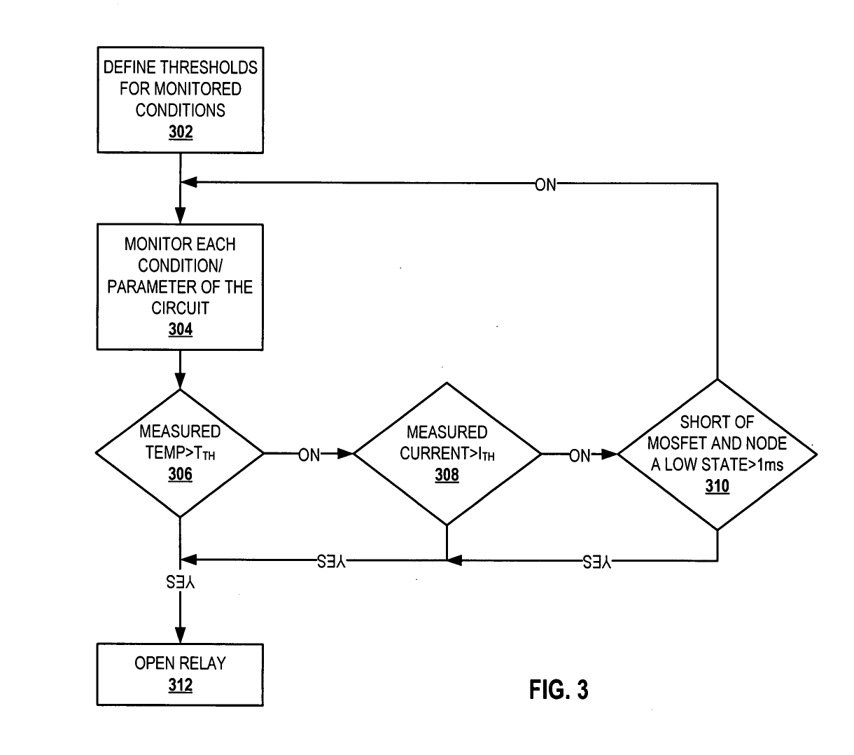

FIG. 3 is a flow chart of the process steps for completing the functions of the above described circuit device. For each parameter, a predefined threshold value is established, as shown at block 302. In one embodiment, the thresholds may be determined based on an analysis/test of the circuit components in combination with operating characteristics for the respective devices. During operation of the circuit, each of several operating conditions/parameters of the circuit are monitored as shown at block 304, and a series of determinations made at blocks 306, 308, and 310 whether any one of the monitored conditions exceeds the pre-set threshold for that condition. If any one of the measured parameters exceeds the predefined threshold, the circuit logic automatically turns off (i.e., opens) the relay, as indicated at block 312. Opening the relay disconnects the energy path to the boost stage switching device and protects the EMC components.

While the invention has been particularly shown and described with reference to a preferred embodiment, it will be understood by those skilled in the art that various changes in form and detail may be made therein without departing from the spirit and scope of the invention.

What is claimed is:

1. An electronic circuit comprising:
a set of EMC components
a boost stage coupled to the EMC components and comprises a relay/latch that is controllably opened and closed based on current operating conditions of the circuit;
operating-condition monitoring means for determining when one or more of pre-defined fault conditions is initiated within the boost stage; and
fault response mechanism that automatically causes the latch/relay to open when any one of the pre-defined fault conditions initiates, wherein the latch is opened substantially immediately when the fault condition is detected and prevents high power dissipation and smoking within the EMC components;
wherein high power dissipation and smoking is prevented from occurring within the EMC components when the boost stage undergoes the fault condition.

2. The circuit of claim 1, wherein the boost stage further comprises:
a plurality of capacitors C4 124 and C5 134;
an inductor L3 126 coupled to capacitor C4 124 via the relay;
a diode D1 132 coupled to inductor L3 at a connection node; and
a transistor Q1 128 coupled to the connection node;
wherein capacitor C5 is coupled to diode D1 across transistor Q1; and
wherein said circuit comprises means for disconnecting a primary energy source from transistor Q1 whenever a fault condition is detected within the boost stage.

3. The circuit of claim 4, wherein the boost stage further comprises:
a branch comprising diode D2 152 series-connected to resistor R1 154, said branch connected parallel to a second branch comprising K1, L3 and D1 coupled between C4 and C5;
wherein said branch boosts stage components between CR1 and T1.

4. The circuit of claim 1, wherein the boost stage further comprises:
a current source latch 158 with programmable connection to relay K1 and which (a) monitors the operating current within the boost stage, (b) determines when the current passed a pre-set threshold maximum current and (c) responds to an over-threshold reading of the current by sending a signal to switch off/open relay K1;
a voltage monitoring/determining logic (VDET) 156 that (a) determines the operating voltages of the boost stage, (b) determines when the voltage passes a pre-set threshold and (c) responds to an over-threshold reading of the voltage by sending a signal to switch off/open relay K1; and
a temperature sensing logic (thermometer) 160 coupled to inductor Q1 128, which (a) monitors the operating temperature of the boost stage, (b) determines when the temperature goes above a pre-set threshold temperature and (c) responds to an over-threshold reading of the temperature by sending a signal to switch off/open relay K1.

5. The circuit of claim 1, wherein said set of EMC components constitute an EMC filter, said filter comprising:
alternating capacitors C1 112, C2 116 and C3 120; and
inductors L1 114 and L2 118 interspersed between the alternating capacitors C1 and C2 and C2 and C3.

6. The circuit of claim 5, wherein the EMC filter further comprises:
dual alternating current (AC) input nodes, with a first node coupled to an input fuse F1 104, which is in turn coupled to a first AC input.

7. The circuit of claim 1, further comprising an AC bridge CR1 122 via which EMC filter is coupled to boost stage.

8. The circuit of claim 1, further comprising a chopper stage, which comprises:
a transistor Q2 136; and
a transformer T1 138 with input terminals coupled to a connection node between diode D1 and capacitor C5 and an output of transistor Q2.

9. The circuit of claim 8, wherein the connection node is a high frequency, high voltage switching node.

10. The circuit of claim 9, further comprising:
a gate input voltage fed by a boost pulse width modulating signal to transistor Q1; and
a second gate input voltage fed by a chop pulse width modulated signal to transistor Q2.

11. The circuit of claim 8, wherein the transistor Q2 is a MOSFET.

12. A method for responding to a fault condition in a circuit deigned according to claim 4.

13. A computer device having therein a boost stage with fault tolerant configuration designed according to claim 4.
